(19) United States
(12) Patent Application Publication
(10) Pub. No.: US 2007/0091126 A1
(43) Pub. Date: Apr. 26, 2007

(54) Interface device

(76) Inventors: Isao Kohda, Osaka (JP); Takashi Tamura, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,074

(22) Filed: Oct. 26, 2005

(51) Int. Cl. G09G 5/00

(52) U.S. Cl. 345/636

(57) ABSTRACT

The image processing device of the present invention comprises a presentation means for presenting on a screen a function for which a corresponding setting has been modified from a default value, and a resetting means for resetting a setting corresponding to a function selected from among the functions presented by a selection operation that is performed by a user. Functions for which the setting is different from the default value are presented on a single screen, it being possible to select a plurality of functions on the same screen, so that the setting of the selected functions can be reset.

### FIELD OF THE INVENTION

The present invention relates to an interface device to be used in an apparatus capable of modifying the settings of a function via the screen of a control panel or the like.

### BACKGROUND INFORMATION

Some image processing devices comprise a control panel such as a liquid-crystal display or a CRT as user interface. With such an image processing device, it is possible to modify or reset settings to be used as execution conditions for various functions.

Prior to printing or copying, a user verifies the settings for each function currently set and modifies the settings for each function with the user's desired values. In order to allow this operation to be performed simply and rapidly, storage devices are known, which display on a screen only the names of the functions for which settings have been modified from the default values. By displaying the names of the factions for which settings have been modified from the default values, the user can recognize at one glance the functions for which settings are not the default values.

When resetting the settings, the user first selects on a screen the function name of which the settings are to be reset. When the functions name is selected, a screen is displayed, which allows the settings for the selected functions names to be modified by the user. When this screen is displayed, the user enters the default values in the screen. The storage device handles the entered default values as settings.

When resetting the settings for a plurality of functions, the user performs the procedure for each functions.

However, in the conventional storage device, as the resetting procedure is performed for each functions, when settings have to be reset for multiple functions, the resetting procedure must be repeated for the same number of times as there are functions to be reset, taking tremendous effort and time for the resetting procedure.

Thus, it is an object of the present invention to provide an image processing device capable of simply and rapidly resetting settings.

### SUMMARY OF THE INVENTION

The interface device of the present invention comprises a presentation means for presenting on a single screen only functions for which a setting has been modified from a default value, and a resetting means for resetting a setting corresponding to a function selected from among the functions presented on the same screen by a user selection operation.

Thus, simply by selecting a function for which a setting is different from the default value, the selected setting is reset.

Thus, when functions that are presented on a single screen are selected, the image forming device of the present invention resets the settings of the selected function. Therefore, when settings are to be reset for a plurality of functions, simply by selecting a plurality of functions for which the settings are to be reset on a single screen, all of the desired settings are reset. Thus, the image forming device of the present invention allows for simple and rapid resetting of settings.

### BRIEF DESCRIPTION OF THE DRAWINGS

FIG. 1 is a functional block diagram of the image processing device of the present invention.

FIG. 2 is a conceptual diagram of data stored in a storage means.

FIG. 3 is a schematic view of an initial screen on a control panel.

FIG. 4 is a schematic view of a screen for modifying user settings.

FIG. 5A and FIG. 5B are schematic views of a validation screen.

FIG. 6 is a flowchart showing a procedure for resetting user settings as a batch.

FIG. 7 is a schematic view of a screen in which function names for which flag regions are enabled are displayed in a mode that is different from other function names.

FIG. 8 is a flowchart showing a procedure for resetting user settings as a batch.

### DETAILED DESCRIPTION OF THE PREFERRED EMBODIMENTS

### Embodiment 1

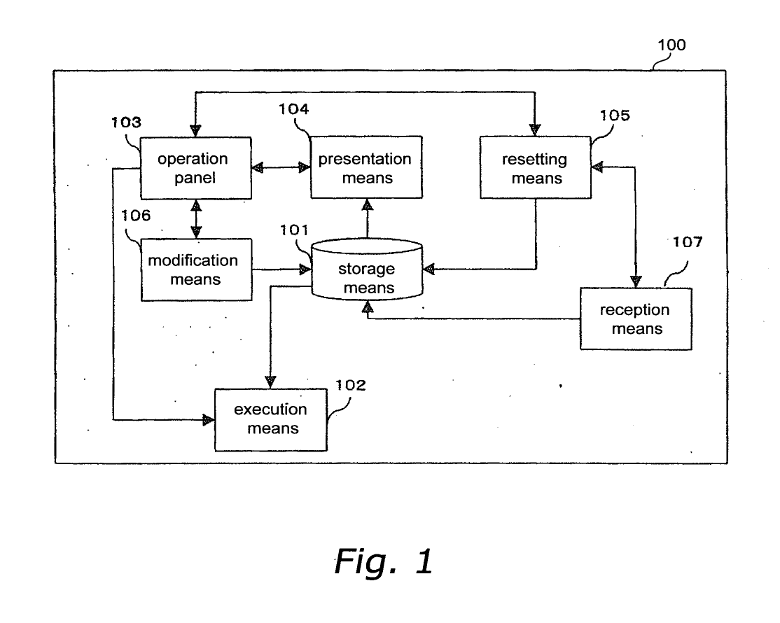

The image processing device 100 of the present embodiment, as shown in FIG. 1, comprises an execution means 102 for executing copy instructions, facsimile transmission instructions, document read instructions and the like. The execution means 102 is capable of executing a process using a plurality of functions. These functions cover, for instance, sorting of printed documents, double-sided/single-sided printing, sheet size, copy density, image print quality, frame removal and the like. A user can set whether or not to enable functions for sorting printed documents, double-sided printing, single-sided printing or frame removal, and can set sheet sizes, copy density and image print quality, using a control panel 103.

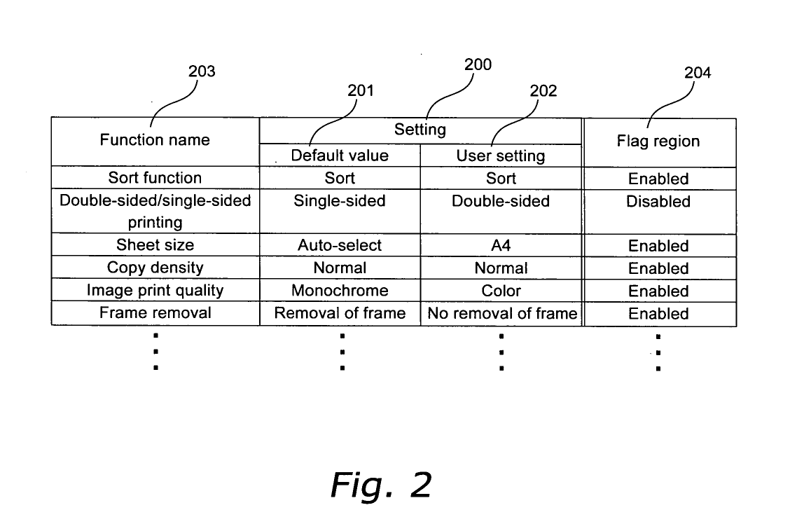

Settings 200 representing whether or not to enable the functions for sorting printed documents, double-sided printing, single-sided printing or frame removal, as well as sheet size, copy density and image print quality are stored in the storage means 101 of the image processing device 100, as shown in FIG. 2. The settings stored in the storage means 101 include both default values 201 for each setting, and user settings 202 set by the user using the control panel 103.

When a copy instruction, a facsimile transmission instruction, a document read instruction or the like is made, the execution means 102 executes these instructions based on the user settings 202 stored in the storage means 101.

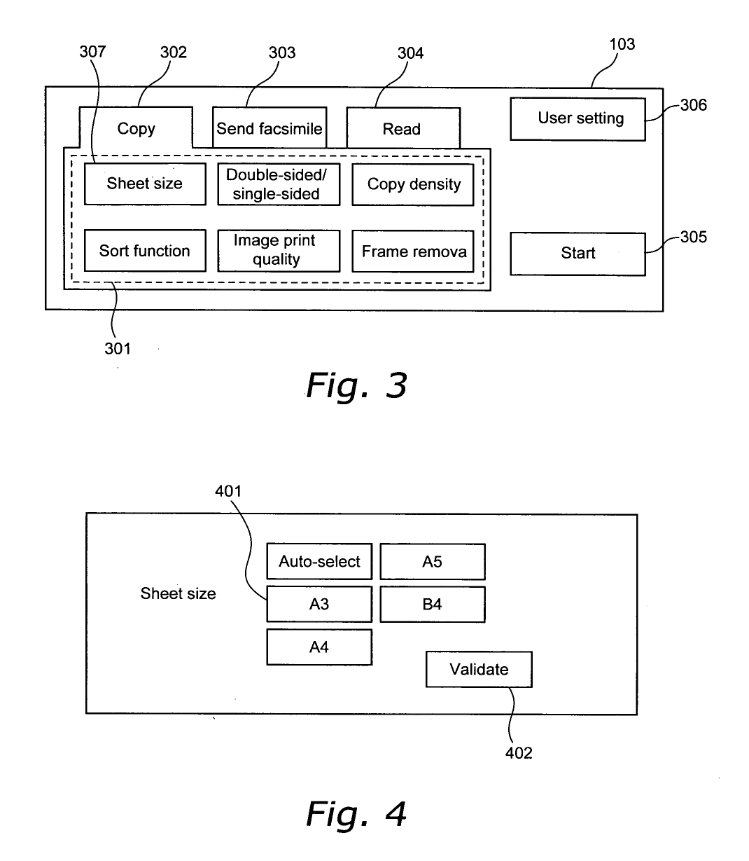

As shown in FIG. 3, a function key group 301 consisting of keys for functions related to copy instructions, which are among the functions for which the settings 200 are stored in the storage means 101, instruction input keys 302 to 304 for entering copy instructions, facsimile transmission instructions or document read instructions, a start key 305, and a user setting key 306, are displayed on an initial screen of the control panel 103.

The function key group 301 for copy instructions is displayed on the initial screen, and if one of the instruction input keys 302 to 304 is pressed, a function key group comprising keys for a function, which is among the functions for which the settings 200 are stored in the storage means 101, and which relates to the instruction input key 302-304 that was pressed, is displayed in the control panel 103. Thus, for instance, when a user presses the instruction input key 303 for a facsimile transmission instruction, a function key group consisting of keys for functions related to the facsimile instruction, which is one of the functions for which settings 200 are stored in the storage means 101, is displayed, and if the instruction input key 304 for a document read instruction is pressed, a function key group consisting of keys for functions related to the document read instruction, which is among the functions for which settings 200 are stored in the storage means 101, is displayed.

When one key constituting a function key group is pressed, a modification means 106 displays on the control panel 103 a screen for modifying the user setting 202 for the function stored in the storage means 101 for which the key was pressed.

For instance, if the user presses key 307 for the sheet size shown in FIG. 3, the modification means 106 displays a screen for modifying the user setting 202 for the sheet size, such as shown in FIG. 4.

For instance, when the user desires to set the user setting 202 to A3 paper, the user selects an A3 key 401 displayed on the screen of FIG. 4 and presses a validation key 402. When the validation key 402 is pressed, the modification means 106 modifies the user setting 202 for the sheet size stored in the storage means 101 into A3. In addition, when the validation key 402 is pressed, the modification means 106 returns the control panel 103 to the initial screen.

In this way, the user can modify the user setting 202 for each function separately, by using the control panel 103.

In addition, when a copy instruction or the like is to be executed by the execution means 102, the user presses the instruction input key 302-304 for the desired instruction which is to be executed, and then presses the start key 305. When the start key 305 is pressed, the execution means 102 executes the instruction corresponding to the last entered instruction input key 302-304, based on the user settings 202 stored in the storage means 101.

Consequently, by separately modifying the user settings 202 as described above before the execution means 102 executes the instruction, the instruction can be executed by the execution means 102 according to the user setting 202 desired by the user.

Although it is possible to reset the user settings 202 for each function by changing the user settings 202 to the same values as the default values 201 with the method described above, when resetting user settings 202 for a plurality of functions, pressing an instruction input key 302-304 and the desired key to be reset, so as to display a screen such as shown in FIG. 4, and then entering the default values several times, is bothersome.

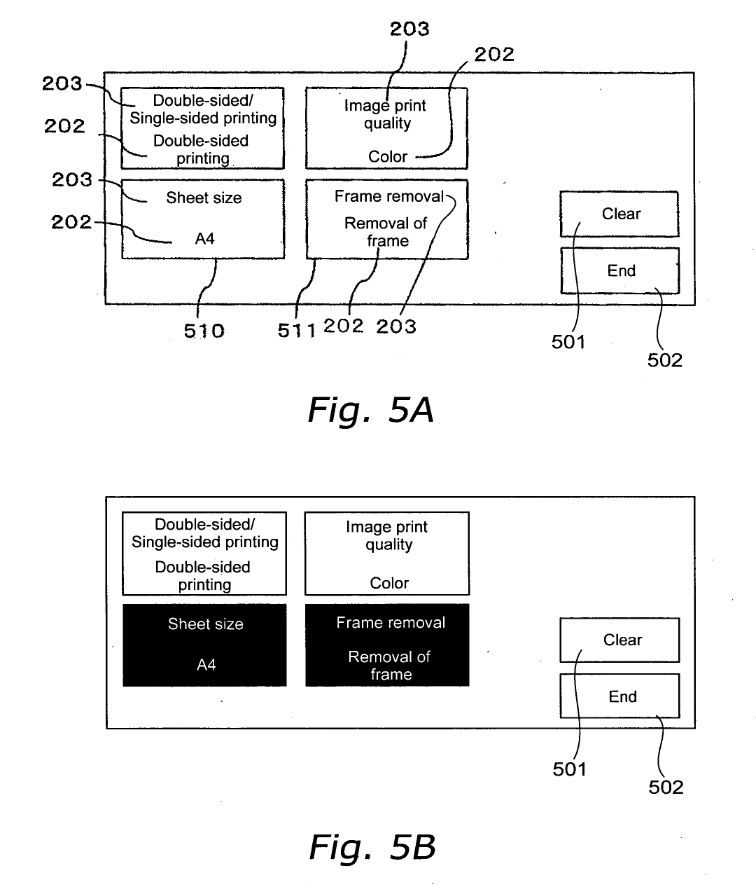

Therefore, to reset user settings as a batch, rather than individually, the user presses the user setting key 306 on the initial screen. When the user setting key 306 is pressed, a presentation means 104 displays on the control panel 103 a validation screen for user settings 202, such as shown in Fig. 5A, by way of the procedure described below.

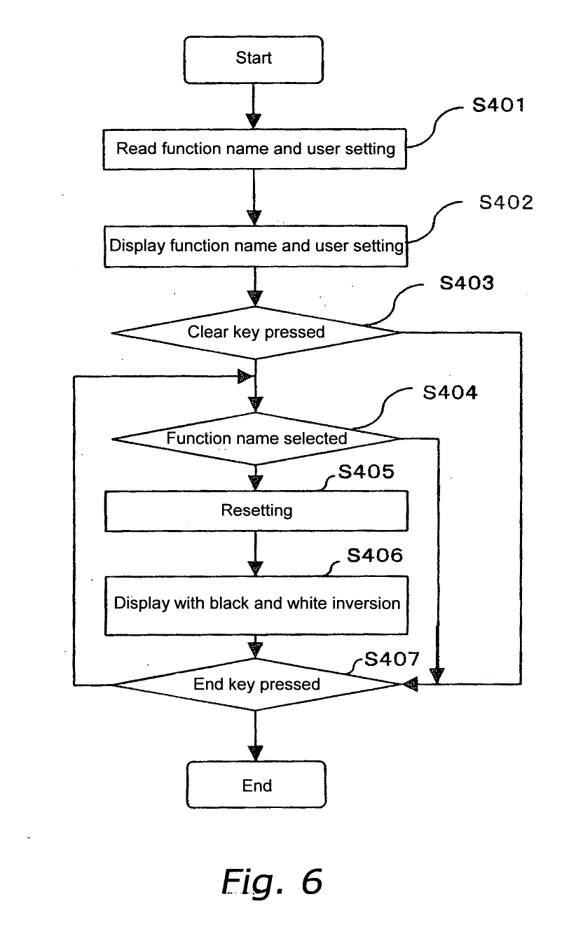

When the user setting key 306 is pressed, the presentation means 104 references the storage means 101 so as to read the user settings 202 that are different from the default values 201 and the function names 203 thereof (FIG. 6, S401). In the present embodiment, the user settings 202 and the default values 201 are different for the functions of double-sided/single-sided printing, sheet size, image print quality and frame removal, as shown in FIG. 2. Consequently, in the present embodiment, the function names 203 and the user settings 202 for the functions of double-sided/single-sided printing, sheet size, image print quality and frame removal are read. The presentation means 104 displays the function names 203 and user settings 202 that have been read on the control panel 103, as shown in FIG. 5A (FIG. 6, S402).

Thus, simply by pressing the user setting key 306, the user can identify the function names 203 for which the user settings 202 differ from the default values 201, and the user settings 202 of these functions 203.

If the function name 203 for which the user wishes to reset the user setting 202 is present among the functions names 203 presented on the control panel 103, the user presses a clear key 501 and single-clicks the name 203 of the fimction the user wishes to reset (FIG. 6, S403 to S404). If there are a plurality of function names for which the user wishes to reset the user settings 202, the user single-clicks all the function names 203 for which the user wishes to reset the user settings 202.

The pressing of the clear key 501 and the function names 203 that were single-clicked are entered to the resetting means 105. After the pressing of the clear key 501 has been entered, the resetting means 105 changes the user settings 202 corresponding to the input function names 203 to the same values as the default values 201 (FIG. 6, S405). When the values are the same as the default values 201, the resetting means 105 displays the function names 203 that have been reset with black/white inversion, so as to inform the user that resetting is complete, as shown in FIG. 5B (FIG. 6, S406).

After the user setting 202 for each function is set to the value desired by the user by way of resetting or modifying the user setting 202, the user presses the end key 502 shown in FIG. 5B (FIG. 6, S407). When the end key 502 is pressed, the resetting means 105 returns the control panel 103 to the initial screen.

Thus, the user can reset the user setting 202 simply by single-clicking and selecting the function name 203 for which the user wishes to reset the user setting 202. Accordingly, if the user wishes to reset the user settings 202 for a plurality of functions, the user can reset the user setting 202 for all of the desired functions, simply by single-clicking as many times as there are functions for which the user wishes to reset the user setting 202.

Note that, if a function name 203 displayed on the validation screen shown in FIG. 5A is selected by double-clicking, the modification means 106 may display a screen such as shown in FIG. 4 to allow the user setting 202 for the fimction name 203 that has been double-clicked to be modified.

### Embodiment 2

In this embodiment, a constitution will be described in which resetting of a user setting 202 can be prevented when a user has mistakenly selected a function name 203 for which the user does not wish to reset the user setting 202. The procedure is the same as the procedure described in Embodiment 1, up to the display of the validation screen shown in Fig. 5A.

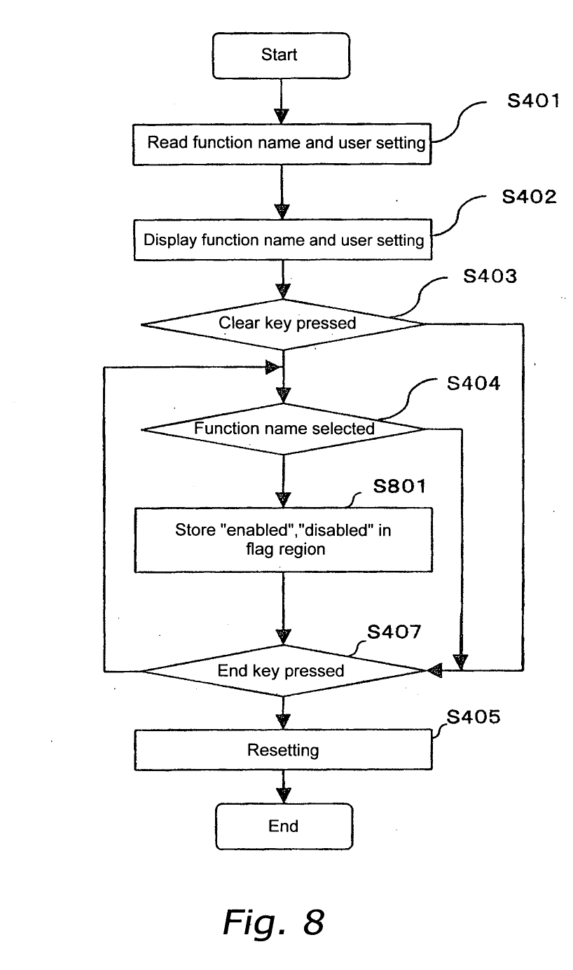

When a function name 203 is single-clicked on the validation screen shown in FIG. 5A, the resetting means 105 stores “enabled” in a flag region 204 corresponding to a region of the storage means 101 where the single-clicked function name 203 is stored (FIG. 8, S801).

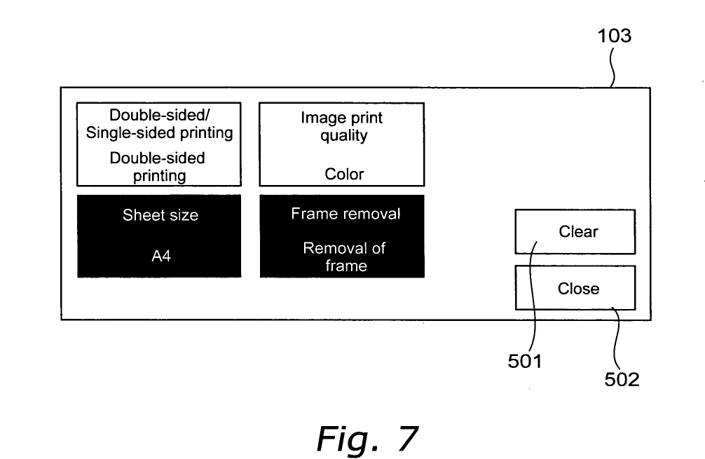

The resetting means 105 displays the function name 203 with “enabled” stored in the flag region 204 in a different mode from that of the other function names 203, as shown in FIG. 7, and communicates the function name 203 that is displayed in a different mode from that of the other function names 203 to a receiving means 107.

If the function name 203 that displayed in a different mode is single-clicked, the receiving means 107 recognizes a cancellation instruction for the selection of the single-clicked function name 203, and communicates the single-clicked function name 203 to the resetting means 105. The resetting means 105 updates the flag region 204 corresponding to the function name 203 that was communicated by the receiving means 107 to “disabled” (FIG. 8, S801), while at the same time, it displays the function name 203 that was communicated by the receiving means 107 in the control panel 103 in the original display mode.

The resetting means 105 resets only the user setting 202 of the function name 203 for which the flag region 204 is “enabled” when the end key 502 is single-clicked (FIG. 8, S407 to S405).

Thus, even if the user mistakenly single-clicks a function name 203 that the user does not wish to reset, the resetting can subsequently be prevented by single-clicking this function name 203 again.

Herein, examples were given for image processing devices such as printer, copier and facsimile; however the present invention is applicable to all apparatus capable of modifying function settings on a screen such as a control panel.

What is claimed is:

1. An interface device comprising:
a presentation means for presenting on a single screen only functions for which a setting has been modified from a default value; and
a resetting means for resetting a setting corresponding to a function selected from among the functions presented on the same screen by a user selection operation.

2. The interface device as recited in claim 1 comprising a receiving means for receiving a cancellation instruction to cancel the selection by the selection operation.

3. The interface device as recited in claim 1, wherein the presentation means also presents the settings corresponding to the function presented.
